(19) United States
(12) Patent Application Publication
(10) Pub. No.: US 2015/0019309 A1
(43) Pub. Date: Jan. 15, 2015

(54) SYSTEM TO FACILITATE AFFILIATE MARKETING

(71) Applicant: Brendon Miskell, Sydney (AU)

(72) Inventor: Brendon Miskell, Sydney (AU)

(21) Appl. No.: 13/941,514

(22) Filed: Jul. 14, 2013

(51) Int. Cl. G06Q 30/02

(52) U.S. Cl. CPC G06Q 30/0214
USPC 705/14.16

(57) ABSTRACT

A system to facilitate affiliate marketing that includes a server system, a first memory system residing on the server system and a website with a plurality of web pages to measure and monitor to facilitate affiliate marketing. The system includes a plurality of users that are a plurality of members of the system to facilitate affiliate marketing. The users include a plurality of sellers supplying one or more goods or services to the system to facilitate affiliate marketing, a plurality of buyers purchasing the one or more goods or services to the system to facilitate affiliate marketing, a plurality of introducer affiliates introducing one or more new users to the system to facilitate affiliate marketing, a plurality of referral affiliates referring a potential buyer to a potential seller, or referring a potential seller to a potential buyer and a network operator operating and maintaining the system to facilitate affiliate marketing.

### BACKGROUND OF THE INVENTION

1. Field of the Invention

The present invention is a system to facilitate affiliate marketing. More specifically, the present invention is a system to facilitate affiliate marketing that hosts an online business network cooperative.

2. Description of the Related Art

Affiliate marketing is a type of performance-based marketing in which a business rewards one or more affiliates for each visitor or customer brought about by the affiliate's own marketing efforts.

In known systems of affiliate marketing, affiliates use their own web-based initiatives to encourage potential customers to visit their own web page and click on a particular hyperlink, referred to as a tracking link, on the web page. The hyperlink redirects the potential customer directly to a site operated by the seller, also known as a merchant or a retailer, where the visitor has an opportunity to make a purchase. The tracking link includes an embedded code to enable the seller (i.e. online merchant) to identify those visitors who arrived via the affiliate's link.

In conventional affiliate marketing, sellers are at risk of having their reputation damaged due to unscrupulous behavior by affiliates. For example affiliates may make false claims or trap readers into clicking links that don't truthfully disclose the nature of an offer. Also, it has been known for unauthorized parties to hijack the tracking links of affiliates and steal their commissions. Conventional online affiliate marketing encourages the use of search engine optimization for the purpose of driving traffic to a tracking link on an affiliate's website. Also, conventional online affiliate marketing encourages the duplication of website content on multiple websites as a way of attracting more customers.

In one form of affiliate marketing, the affiliate is paid based on the volume of visitor traffic directed to the seller's web page. The seller is therefore rewarding the affiliate for traffic that does not have any guarantee of converting into sales. Also, anyone reading the web page may click on the tracking link, so the seller has no control over the types of customers that are targeted.

In another form of affiliate marketing, the affiliate is paid based on the number of visitors who make a purchase from the seller within a limited time period, such as 24 hours. The affiliate is not rewarded if the potential buyer returns after that period. Also, the affiliate is not rewarded if the potential buyer declines to make a purchase at the time of the first visit, and returns to the seller's site another time to make the purchase without passing via the affiliate's hyperlink.

### BRIEF SUMMARY OF THE INVENTION

The present invention is a more advanced system to facilitate affiliate marketing. More specifically, the present invention is a system to facilitate affiliate marketing that hosts an online business network cooperative.

The system to facilitate affiliate marketing that hosts an online business network cooperative includes a server system with a first processor system, a communications interface, a first communications system, a first input system and a first output system, the server system having access to a communications network, a first memory system with an operating system, a communications module, a web browser module, a web server application and an affiliate marketing facilitation application, the first memory system residing on the server system and a website with a plurality of web pages to receive a plurality of affiliate marketing data, the website residing on the affiliate marketing facilitation application. The system is utilized by a plurality of users, wherein the users are a plurality of members of the system to facilitate affiliate marketing, the users include a plurality of sellers supplying one or more goods or services to the system to facilitate affiliate marketing, a plurality of buyers purchasing the one or more goods or services to the system to facilitate affiliate marketing, a plurality of introducer affiliates introducing one or more new users to the system to facilitate affiliate marketing, a plurality of referral affiliates referring a potential buyer to a potential seller, or referring the potential seller to the potential buyer and a network operator operating and maintaining the system to facilitate affiliate marketing. The system also includes a plurality of incentives to the users and a plurality of reward systems to the users.

It is an object of the present invention to provide a system to facilitate affiliate marketing that provides relatively greater trust and transparency between members than traditional online affiliates and members of the public.

It is an object of the present invention to provide a system to facilitate affiliate marketing that works with known contacts in a cooperative that introduces a plurality of known contacts that tend to be more careful in their behaviour than traditional online affiliates and members of the public.

It is an object of the present invention to provide a system to facilitate affiliate marketing that reduces spamming and improves privacy.

It is an object of the present invention to provide a system to facilitate affiliate marketing that prevents unauthorized parties from hijacking the tracking links of affiliates and stealing their commissions.

It is an object of the present invention to provide a system to facilitate affiliate marketing where affiliates are rewarded for successful transactions, regardless of the time elapsed since they were referred.

It is an object of the present invention to provide a system to facilitate affiliate marketing where depending on the type of membership affiliates may be rewarded in a variety of ways, including cash, rewards and special offers.

It is an object of the present invention to provide a system to facilitate affiliate marketing where affiliates are part of an online business network cooperative so their needs are respected as much as any other member.

It is an object of the present invention to provide a system to facilitate affiliate marketing where affiliates do not need to create separate websites to draw in potential buyers.

It is an object of the present invention to provide a system to facilitate affiliate marketing that is not search engine optimization or SEO driven.

It is an object of the present invention to provide a system to facilitate affiliate marketing that provides its affiliates an opportunity to earn a residual income.

It is an object of the present invention to provide a system to facilitate affiliate marketing that utilizes the Dunbar Rule of 150 regarding close ties and social cohesion, wherein everyone tends to maintain only a maximum of only 150 close ties connections.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a block diagram of a system to facilitate affiliate marketing, in accordance with one embodiment of the present invention.

FIG. 2 illustrates a block diagram of a server system, in accordance with one embodiment of the present invention.

FIG. 3 illustrates a block diagram of a client system, in accordance with one embodiment of the present invention.

FIG. 4 illustrates a diagram of an introducer affiliate system, in accordance with one embodiment of the present invention.

FIG. 5 illustrates a diagram of an introducer affiliate system, in accordance with one embodiment of the present invention.

FIG. 6 illustrates a diagram of a referral affiliate system, in accordance with one embodiment of the present invention.

FIG. 7 illustrates a diagram of a plurality of revenue splits of a referral affiliate rewards system, in accordance with one embodiment of the present invention.

FIG. 8 illustrates a block diagram of one or more business members selling one or more products and services, in accordance with one embodiment of the present invention.

FIG. 9 illustrates a block diagram of a network operator selling one or more products and services, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

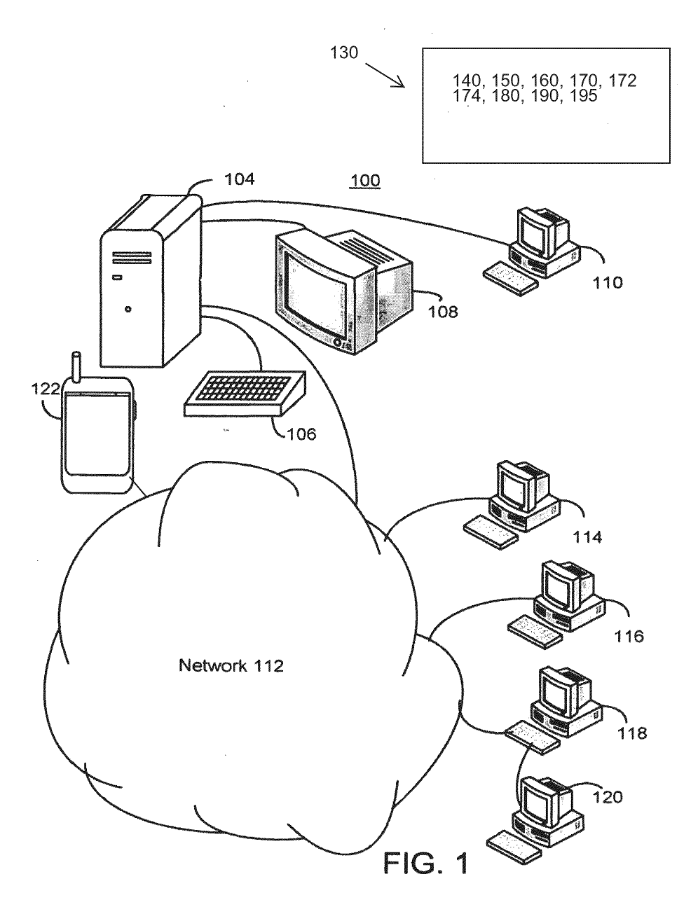

FIG. 1 illustrates a block diagram of a system 100 to facilitate affiliate marketing, in accordance with one embodiment of the present invention.

FIG. 1 illustrates a system overview of a system 100 to facilitate affiliate marketing. The system 100 includes a server system 104, a first input system 106, a first output system 108, a plurality of client systems 110, 114, 116, 118 and 120, a communications network 112 and a hand-held device 122. In other embodiments, the system 100 may include additional components and/or may not include all of the components listed above.

The server system 104 may include one or more servers. One server 104 may be the property of the distributor of any related software. In other embodiments, the system 100 may include additional components and/or may not include all of the components listed above.

The first input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB).

The first output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The system 100 illustrates some of the variations of the manners of connecting to the server system 104, which may be an information providing website 216. The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals. The client systems 110, 114, 116, 118 and 120 are any system that an end user may use to access the server system 104. For example, the client systems 110, 114, 116, 118 and 120 may be personal computers, cell phones with an operating system or SMARTPHONES®, workstations, laptop computers, game consoles, hand held network enabled audio/video players and/or any other network appliance.

The client system 120 accesses the server system 104 via the combination of the communications network 112 and another system, which in this example is client system 118. The client system 120 may be an example of a handheld wireless device 122, such as a SMARTPHONE® or a handheld network enabled audio/music player, which may also be used for accessing network content.

The system 100 includes a plurality of users 130, wherein the users 130 are a plurality of members of the system 100 to facilitate affiliate marketing. The users 130 include a plurality of sellers 140 supplying one or more goods or services to the system 100 to facilitate affiliate marketing, a plurality of buyers 150 purchasing the one or more goods or services to the system 100 to facilitate affiliate marketing, a plurality of introducer affiliates 160 introducing one or more new users to the system 100 to facilitate affiliate marketing and a plurality of referral affiliates 170 referring a potential buyer 172 to a potential seller 174, or referring the potential seller 172 to the potential buyer 174. The system 100 also includes a network operator 180 operating and maintaining the system 100 to facilitate affiliate marketing, a plurality of incentives 190 to the users and a plurality of reward systems 195 to the users.

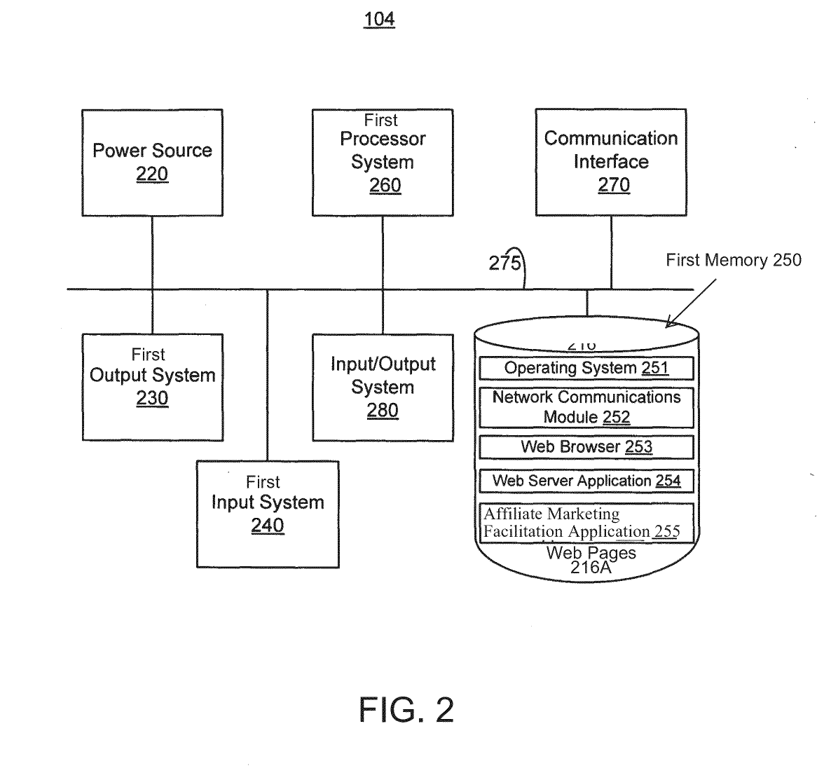

FIG. 2 illustrates a block diagram of a server system 104, in accordance with one embodiment of the present invention.

FIG. 2 illustrates a block diagram of a server system 104 that may be used to facilitate affiliate marketing. The server system 104 may include a website 216, a power source 220, a first output system 230, a first input system 240, a first memory system 250, which may store an operating system 251, a communications module 252, a web browser module 253, a web server application 254 and an affiliate marketing facilitation application 255. The server system 104 may also include a first processor system 260, a communications interface 270, a communications system 275 and an input/output system 280. In other embodiments, the server system 104 may include additional components and/or may not include all of the components listed above.

The website 216 includes a plurality of web pages 216A to receive a plurality of affiliate marketing data. The website 216 resides on the first memory system 250.

The first output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The first input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., Infrared Data Association or IrDA and Universal Serial Bus or USB).

The first memory system 250 may include, for example, any one of, some of, any combination of, or all of a long term storage system, such as a hard drive;

a short term storage system, such as random access memory; a removable storage system, such as a floppy drive or a removable drive and/or a flash memory. The first memory system 250 may include one or more machine readable mediums that may store a variety of different types of information. The term machine readable medium may be used to refer to any medium capable of carrying information that may be readable by a machine. One example of a machine-readable medium may be a computer-readable medium. The memory system 250 may store one or more machine instructions. The operating system 251 controls all software and hardware of the system 100. The communications module 252 enables the server system 104 to communicate on the communications network 112. The web browser module 253 allows for browsing the Internet. The web server application 254 serves a plurality of web pages 216A to client systems 120 that request the web pages 216A, thereby facilitating browsing on the Internet.

The first processor system 260 may include any one of, some of, any combination of, or all of multiple parallel processors, a single processor, a system of processors having one or more central processors and/or one or more specialized processors dedicated to specific tasks. The first processor system 260 may implement the machine instructions stored in the memory system 250.

In an alternative embodiment, the communication interface 270 allows the server system 104 to interface with the network 112. In this embodiment, the first output system 230 sends communications to the communication interface 270. The communications system 275 communicatively links the first output system 230, the first input system 240, the first memory system 250, the first processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 may be optional and may be used in addition to or in place of the first output system 230 and/or the first input system 240.

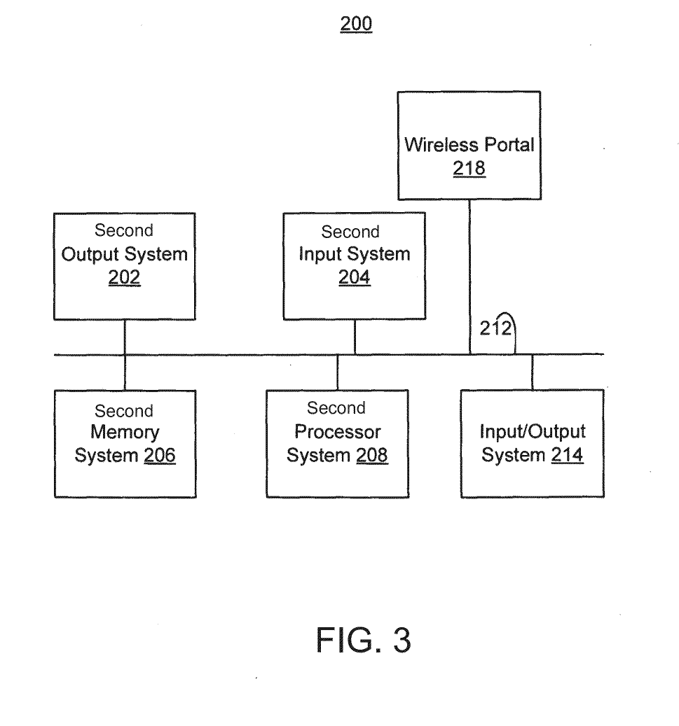

FIG. 3 illustrates a diagram of a client system 200, in accordance with one embodiment of the present invention.

FIG. 3 illustrates a block diagram of a client system 200 that may be used as one of the system units to facilitate affiliate marketing. The client system 200 may include a second output system 202, a second input system 204, a second memory system 206, a second processor system 208, a communications system 212, an input/output system 214 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The second output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, an intranet, and/or the Internet, for example.

The second input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., IrDA or USB), for example. The second memory system 206 may include, for example, any one of, some of, any combination of or all of a long term storage system, such as a hard drive, a short term storage system, such as a random access memory; a removable storage system, such as a floppy drive or a removable drive, and/or a flash memory. The second memory system 206 may include one or more machine readable mediums that may store a variety of different types of information. The term machine readable medium may be used to refer to any medium that may be structurally configured for carrying information in a format that may be readable by a machine. One example of a machine-readable medium may be a computer-readable medium. The second memory system 206 also stores an application to facilitate affiliate marketing.

The second processor system 208 may include any one of, some of, any combination of, or all of multiple parallel processors, a single processor, a system of processors having one or more central processors and/or one or more specialized processors dedicated to specific tasks. The second processor system 208 implements the programs stored in the memory system 206 to facilitate affiliate marketing. The communications system 212 communicatively links the output system 202, the input system 204, the memory system 206, the second processor system 208, and/or the input/output system 214 to each other. The communications system 212 may include any one of, some of, any combination of, or all of one or more electrical cables, fiber optic cables, and/or one or more methods of sending signals through air or water (i.e., wireless communications), or the like. Some examples of one or more methods of sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 may be optional, and may be used in addition to or in place of the output system 202 and/or the input device 204.

The client systems 110, 114, 116, 118, 120 and the handheld wireless device 122 may also be in communication with a website 216 or a wireless portal 218 which may be also tied directly into the communications system 212. Any website 216 or wireless portal 218 would also include the affiliate marketing facilitation application 255 that to maintain, allow access to and run the website 216 as well.

The system to facilitate affiliate marketing involves hosting an online business network cooperative in which affiliates operate. The system has two kinds of affiliates, an introducer affiliate which may be a member of the system who introduces a new member to the system and a referral affiliate which may be a member of the system who either refers a potential buyer to a seller, or refers a seller to a potential buyer. Referral affiliates may only introduce members who are their first degree connections within the system.

A first degree connection with a member indicates there may be evidence of either having a direct connection with the member (such as a social media website or a LINKEDIN® connection or other social media connection) or of having directly used the services of that member previously. In addition, the business network cooperative has an introduction system for automatically matching potential buyers in the system with potentially suitable sellers in the system, and introducing those sellers to the buyers. The introduction system creates a profile for each member based on information submitted voluntarily by the corresponding member, and uses the profile to match buyers with sellers.

Referrals within the system are only made by the introduction system and referral affiliates (who have first degree connections with both parties). The system only makes business referrals when there may be knowledge of the parties being introduced, which encourages better matches and greater trust between buyers and sellers. The business network cooperative has a system of rules and incentives to encourage certain desirable activities in the system and desirable outcomes for the members. One of these desirable activities may be for members of the system to take on the role of an introducer affiliate or referral affiliate.

Important features of the system include referral affiliates that are rewarded by the network for business referrals they make, but only when the referral directly results in a successful transaction between a buyer and a seller between one of the directly referred parties. The reward may be paid when the transaction has been completed. The reward may be therefore performance-based, which encourages affiliates to make bona fide referrals. Introducer affiliates are rewarded by the system for each new member they introduce to the system, but only when the new member conducts a predetermined type of transaction within the system. Examples of transactions include disclosing data about themselves to the system, completing a survey, or making a purchase from a member of the system, or selling goods or services to another member. Each member of the system may operate as an introducer affiliate and also a referral affiliate in fact all parties may occupy any role but only the network operator may singularly perform its own role, other than that all roles are rotational meaning all parties perform multiple roles.

The referral affiliates must be members of the system and may only refer members to other members of the system. All members are registered in the system and must conform to membership rules for the system. This promotes greater trust between members, which provides an atmosphere conducive for members to conduct business. The system tracks financial transactions between members and tracks referral affiliates and introducer affiliates who led to those transactions. Offline transactions (i.e. transactions occurring outside the system) may be tracked if members notify the system of the transaction, such as by logging the transaction on a website for the system or over a mobile (i.e., cell phone) driven application. Members are offered rewards for transactions within the system so they have an incentive to log any offline transactions between members. The system provides an administrative framework for paying rewards to members and systematising the process of making referrals. The system may be a cooperative in the sense that it may be designed for the mutual benefit of its members and a portion of financial turnover in the system may be returned to members in the form of cash and reward points.

Preferably, the system requires affiliates to identify themselves to each member that they refer. This creates transparency and promotes trust and an atmosphere conducive to acting on a referral. Members must have agreed to be in contact with a referral affiliate in order to be referred. Members may reverse this decision (i.e., opt out) at any time. It may be only possible for a referral affiliate to refer another member if the affiliate may be a first degree connection of that member. The system provides a website to be used for affiliate communications. All affiliate contact with members must take place over the website using tools provided for the purpose. This allows affiliate communications to be monitored and checked for appropriateness. It also provides a way to confirm that the affiliate may be contacting people personally known to them, hence reducing the likelihood of spamming and damage to the reputation of the system. The system provides for residual income. As the system tracks transactions between members, it provides an option for referral affiliates and introducer affiliates to be rewarded for one or more subsequent transactions, depending on what may be agreed with sellers. Only members of the system may engage in the activities of the system.

A seller may be a member involved in supplying goods or services to members of the system. A buyer may be a member involved in purchasing goods or services from members of the system. Being a B2B and B2C system it is possible for a seller to also occupy a buying role as well. An introducer affiliate may be a member who introduces a new member to the system. A referral affiliate may be a member who either refers a potential buyer to a seller, or refers a seller to a potential buyer. The network operator may be responsible for operating and maintaining the system the computer network software.

In addition to the affiliate features described above, the system may encourage the following activities and outcomes. The system promotes commercial activity between members of the system, such as the sale of goods and services between members. Ideally, the commercial activity should be for the mutual benefit of the parties involved. The system may be used to promote any type of commercial activity. However, the system has the option of promoting certain types of commercial activity more than others. For example, the system may be set up to promote a particular type of industry, type of business, or geographical region, so the incentives may be structured accordingly.

Growth of the system may be important for growing the database of customer data. The system therefore includes incentives for members to introduce new members to the system. The simplest form of incentive may be a flat incentive (i.e. one which may be the same for all types of members). Alternatively, the structure of the incentives may depend on the desired size and composition of the system. If there may be a shortage of a particular type of member, the incentive for attracting that type of member may be increased. For example, if the system has a greater need for members who are sellers rather than buyers, the incentives for sellers may be increased relative to the incentive for buyers. In another example, if the system has a need for members from a particular industry or geographical area, the incentives for attracting those numbers may be increased.

The system may dynamically vary incentives in response to changes in the size or composition of the system. For example, if the system has a target of achieving a membership in which 90% of members are buyers, the incentive for attracting buyers may be progressively scaled down as the percentage of buyers in the system increases. In another example, if the system has a shortage of members from a particular industry sector, the incentive for attracting members from that sector may be increased, but progressively reduced in response to the growth of members from that sector.

Preferably, the system includes incentives aimed at encouraging buyers in the system to rate their firsthand experience with sellers in the system (i.e., rate customer service standard), and optionally for sellers to rate their firsthand experience with buyers (i.e., promptness of payment, credit rating). It may be important that the ratings are based on firsthand experiences (i.e., buyers have used the services of the seller before). The system may enforce this by requiring evidence that there has been a direct transaction with the member or product or service being rated. As the system has the ability to track transactions between members, this may be easily performed and quality controlled. Preferably, the system retains a record of all e-commerce between members to enable transactions within the system to be verified.

Ratings may include a quantitative rating (such as a score out of 10) and/or a qualitative comment, such as a description of the experience with a seller. The system provides a system for collecting and publishing ratings, such as an online portal or printed forms and publications. Members may select which other members of the system are able to see their member ratings (i.e., only direct contacts or more members).

Preferably, the system includes incentives aimed at encouraging members to source leads (i.e., potential clients) who are relevant to sellers in the system, and to share those leads with the sellers. The leads may comprise potential buyers from within the system as well as potential buyers from outside the system. Information about each lead may be in the form of a name and contact details.

The structure of the incentives may depend on the desired quantity and composition of leads. If there may be a shortage of a particular type of lead, the incentive for attracting that type of lead may be increased. For example, if sellers in the system have a greater need for leads from a particular industry or geographical area, the incentives for attracting those leads may be increased.

The system may dynamically vary incentives for leads in response to the changing needs of sellers. The system encourages individual members and business members to disclose specific types of data about themselves to the system. Members are asked for particular customer data at the time of registration and from time to time after registration (i.e., satisfaction surveys and seller ratings). The amount of reward points earned for the data may be related to the amount and type of data submitted. Examples of personal data include, but are not limited to, age, sex, contact details, employment role, employment industry, spending patterns and personal interests.

It may be currently envisaged that the system membership comprises three types of membership, a consumer (rewards member) a sales agent (business associate) and a business owner (business member). Additional membership types or sub-categories of membership may be created. A consumer (buyer) may be any member type party who buys goods or services from sellers in the system. A sales agent may be a professional licensed sales representative for the network operator. The sales agent may operate as an introducer affiliate for both consumer members and business member members and also for additional sales agents that they themselves introduce or recruit and a referral affiliate for all types of members and be a consumer member. The business member may be a supplier of goods or services to members of the system. A business member membership covers a business entity and any staff of that entity. A business member may operate as an introducer affiliate for both consumer members and also other business members and a referral affiliate for all types of members.

As mentioned above, the system provides incentives to encourage certain activities and outcomes. There are multiple types of incentive. Examples include, but are not limited to a plurality of rewards points, one or more monetary payments and a plurality of membership data. Reward points are a currency which only has value within the system. They are issued by the network operator for a variety of reasons, and may be used as a rebate against purchased goods and services purchased from the network operator and sellers in the system. Rules for issuance and redemption of rewards points are determined by the network operator. Reward points are particularly useful for encouraging commercial activity within the system because they may only be redeemed for goods and services provided by sellers in the system. This form of currency may be therefore recycled within the system. In some circumstances, monetary payments are made to members using a public currency accepted outside the system, for example Australian dollars, Euros or US dollars. In some circumstances buyers may pay for transactions with sellers using a combination of reward points and a public currency.

Membership data comprises information about members, and includes the customer data mentioned above and contact details. Such data may be highly valued due to its commercial applications for other members of the system. The system includes an online business directory with listings for members and a search engine for finding members or goods and services. When the system may be quite large and there are many businesses operating in the same area, their rankings in the search results become important to them. High search rankings are another way to reward members who pursue the desired activities mentioned above. In one example, search rankings are affected by a level of paid membership, length of paid membership, user ratings of the member (if a seller), a number of introductions to the system made by the member and a level of cash transactions put through the system when in a buyer or seller capacity. The system has an incentive structure, which may be a set of rules for determining the type and amount of rewards to be paid to members, and the circumstances in which rewards are paid. The aim of the incentive structure may be to encourage members to do things that benefit the system, and to do them for their own self-interest. The incentive structure encourages the desired activities and outcomes mentioned above. There are many ways in which the incentive structure may be set-up. It may be useful to first understand the motivations of members and their reasons for using the system. For the four types of system members, the individual reasons for using the system may be as follows. For consumers it may be to earn reward points, to exchange reward points for all services of sellers, to gain access to a search engine which aids in the selection of sellers, to gain access to ratings and feedback about sellers in the system, to notify sellers when they have a need for particular goods or services, and to request offers and quotes from relevant sellers, to share the profits of the system and to the network operator that may offer other incentives from time to time, such as supporting charities or fundraising activities.

Business members may obtain customer data so as to aid targeted business offers likely to bring higher sales/conversion rates, obtain both business to business or B2B and business to client or B2C contacts, obtain client referrals, earn reward points and share the profits of the system, be promoted by the system. The network operator may offer other incentives from time to time, such as supporting charities or fundraising activities. Sales agents may earn money, earn reward points and share the profits of the system. Sales agents are able to exchange money for reward points and visa-versa. This type of flexibility and added value to the affiliate may be not available in conventional affiliate marketing systems. The network operator may earn money, may build a valuable database asset and promote a new way of doing business.

Since the system may be a business cooperative, members share in the profits of the system. Each member's share may be a function of extent to which they contributed to the growth of the system. Factors that may be taken into account in an algorithm for calculating each member's share include monthly introduction and referral levels, and the extent to which members purchase services from other members of the system.

### Example of an Incentive Structure

Here may be an example of incentives designed to help achieve the activities and outcomes mentioned above. Incentives for consumers referring business within the system include receiving reward points in return for referring a potential buyer in the network to a potential seller or vice-versa. The payment may be only made when the referral results in a purchase between the potential buyer and seller. The member may also receive residual payments for subsequent transactions involving the same buyer and seller. Consumers are only paid in reward points. Incentives for business members referring business within the system are the same as for the consumers. Incentives for sales members referring business within the system obtain higher reward/payment splits than business members and consumer (rewards) members do but sales agents may be paid in money or rewards points, depending on their preference. There may also be incentives for introducing members that are engaged in buyer or selling actual transactions for a benefit to the introducer or referrer to be realized to the system. Consumers do not receive reward points in return for introducing potential new members to the system.

Business members receive the same rewards points as the consumer (reward members). Sales agents receive a higher level of rewards when compared against the consumer members as they are operating a licensed business via the network operator, sales agents may be paid in either money or rewards points or a combination thereof. All members may introduce and refer all other member types but no reward or monetary entitlement is received from the network operator until such time as a direct transaction results from the introduction or referral made directly by that said member type entity.

Consumers (buyers) can come from any member type and receive reward points for operating as an introducer affiliate or referral affiliate, and reward points in return for buying from members in the system. All member types receive reward points for operating as an introducer affiliate or referral affiliate. Business members receive higher search rankings in return for trading with members in the system. Factors to be considered may include the frequency of transactions, the size and total of those transactions, and the user ratings they receive from members. Sales agents receive money and/or reward points for operating as introducer affiliate or referral affiliate where successful transactions result from these activities. Network operators act in all six potential roles (intro to seller, referrer to seller, intro to buyer, refer to buyer, buyer and seller) so a benefit may be gained commercially in all of these activities by the network operator.

Consumers receive reward points in return for rating a seller based on firsthand experience with that seller. Business members receive the same rewards points as the consumers. All members have an incentive to fill out a profile about themselves to the best of their ability as it helps match them to suitable buyers and sellers. The system may offer rewards for disclosing specific types of data, such as participating in a survey request for that member to do a further survey. Consumers receive reward points in return for disclosing specific types of data about themselves, as defined by the system. The number of reward points may be related to the type and amount of data disclosed. Business members receive the same rewards points as the consumers.

In affiliate marketing the positions that the prospect, affiliate, merchant and network operator occupy may be static and singular in role where there may be no duality of role. The BHIVE® network is by contrast totally dynamic in nature where any party may occupy any role or combination of roles other than being a network operator. Sellers and buyers also have affiliate roles as well, where they get rewarded by introducing the system to facilitate affiliate marketing to others in their network, not just for performing buying and selling roles. This is a completely new design practicing a more advanced form of affiliate marketing or more accurately performance marketing.

The introducer affiliates reward system illustrates that the business member (i.e., seller) may also occupy the buyer's role and the business member may even introduce member parties who become buyers. This never happens in affiliate marketing since the merchant (the equivalent of the business member) never introduces buyer prospects themselves since that role is left solely to the affiliate in the system to facilitate marketing. In the BHIVE® network the business member selling their services to others in the network may also be made an affiliate themselves, which may be a major structural difference. The BHIVE® network may be described as being orbital in nature and constantly revolves in position and is also non-hierarchical since it may be built-on first degree connections only at introduction level and up to second degree connections in regard to referral connection activity. The structural shape of the BHIVE® network system does not mimic the look of the affiliate or the network marketing structure it is entirely original (see FIGS. 10 and 11) and may be likened to how a beehive structure works as it may be built-on cross-pollination from existing cells.

In traditional affiliate marketing the affiliate only interacts with and gets paid on the demand side or the buyer side only. In the BHIVE® network affiliates get rewarded or paid on both the demand buyer side and the supply seller side so long as the introduction is a first degree connection, which is a significant difference. Traditional affiliate marketing is also time sensitive as it normally only measures introductions and referrals over a web link. The BHIVE® network is not time sensitive at all, if someone may be introduced to the BHIVE® network today, they may be noted as the introducer (acting off code link) or simply input of a member number. If that party bought an automobile from a business member six months later, the system to facilitate marketing will recognize the seller as needing to get paid in an ongoing manner. The seller could buy home loans or anything else in this way via the network and again it will recognize the need to pay that member given they are tagged to each other permanently. Also in affiliate marketing it may be possible for a prospect coming in over an affiliate link to be tagged to two affiliates. In the BHIVE® network this is never the case since all incoming parties may be only attached or tagged to one introducing party (there may be no duplicate attachment) so the BHIVE® network follows an attachment for life to a single introducing party and for a referral transaction it will create a single tag to that party but just in reference to a set transaction only. The referring party may not be static however it may rotate on circumstance but an introducing party that was the one that brought them into the network in the first place is always static (i.e., always linked back to only the one singular introducing member entity). In the system to facilitate marketing introducers get paid against every transaction where a buyer or a seller has been brought in but may share commission where someone later successfully acts in a referral capacity with those same introduced parties that they originally introduced. Also in standard affiliate marketing there is normally little to no joint transparency to the affiliate, merchant or prospect on what was bought in and how it occurred for how much and what rewards may be due and to which parties. The BHIVE® network has total transparency to its affiliates they may sight it in their private portal where it may all be on display, so percentage transaction splits are totally transparent to all parties.

The BHIVE® network's innovative structural design has important implications for marketing efficiency and viral marketing in particular. In the software portal of each member they may immediately expose the BHIVE® network opportunity to all their first degree FACEBOOK®, TWITTER® and LINKEDIN® contacts within their immediate social networks, so the capacity to leverage those networks may be extreme, since the system to facilitate marketing works-off members existing and known network connections, so the network may be built layer by layer on “known” connections.

Up until now network marketing has been the only proven (i.e., network based) online and offline distribution method that may effectively move products and services. The BHIVE® network has the potential to challenge this as the key system to facilitate marketing may move products and service more efficiently and not just single product and service focused items like multi-level marketing or MLM does. The system to facilitate marketing may market automobiles, financial services, travel, legal and other suitable products and services since the system to facilitate marketing may be purely a software platform that markets member services. If you look at network marketing it may often be criticized for its pyramid like structural appearance. This may be where the BHIVE® network may be very innovative it is not be following a network marketing structure nor may it be following a pure affiliate marketing structure, it is an entirely new design.

The referral affiliate rewards system may tap-into the referrer's (past buyers of any given service) first and second degree networks simultaneously. Affiliate marketing doesn't and can't do this since it operates off attracting strangers via keyword marking and search engine optimization or SEO. In the BHIVE® network any given member may be able to browse their first degree contacts to see who they may be using as their service providers. For example, if someone looked at a record of a person they knew in the network and they wanted an accountant and then ended-up using that person's accountant that may be also in the network, that person would get a passive referral fee off their transactions. A verbal recommendation may not have been made but it will track what happened and credit the person for making the referral anyway.

With affiliate marketing the merchant has upfront costs to bear in setting-up an affiliate system. In the BHIVE® network this is not the case, since business members (i.e., service sellers) may be the equivalent of merchants and have no upfront costs to bear. They simply do an online performance fee agreement with the BHIVE® network and the software tracks any later transaction with a buyer that was made. The BHIVE® network collects its negotiated fee off this and pays it out in rewards or dollars to the parties that introduced those that became the buyers and sellers. So because any given transactions may be tracked between members including over mobile (i.e., cell phone) payment systems, which many businesses desire as risk-free and pay on results marketing. The BHIVE® network may be a new structure which fits into the genre of performance marketing systems of which affiliate marketing may be a subset of.

In the introducer affiliate rewards system members who introduce these parties may introduce an infinite number of them as long as it may be a first level introduction so the potential buyer and seller parties become infinite in number as the software tracks their buying and selling movements and their combinations of purchasing and selling interactions as soon as they happen and whenever they happen (see FIG. 10 (where business member are selling their services)—so unlimited potential buyer and seller attachments and see FIG. 11 (where BHive company the Network Operator is selling its services) may occur in the introducing or referring parties having the ability to earn unlimited rewards or income off these when the members in the respective buying and selling roles that they are attached to end up engaging in a transaction. The attached introducer that brought them into the network at any time afterwards will get paid or rewarded which may be very different than any affiliate marketing scenario.

However the system to facilitate marketing may be well-beyond traditional affiliate marketing structures. Another key difference in the BHIVE® network and the system to facilitate marketing may be that the system to facilitate marketing runs on three currencies: data trade, money and a rewards system. Affiliate marketing does not utilize a data trade or a rewards system, and generally utilizes money only. With the rewards system the business member services may be actually a reward and may be bought for money by buyers but the company itself (which may be an equivalent of a network operator) also runs a rewards system around them. The member selects the business member service they wish to use their points on and the network operator pays the money equivalent to that business member service on that redeeming member's behalf in real funds into that business members (i.e., sellers) account and that service may then be delivered or consumed at location. This may be all tracked over the world wide web and a mobile phone so if a person walked into a Business Members restaurant that redeemed rewards points the person would show the redeemed rewards points on a mobile phone (i.e., cell phone) or use the receipt number of the credit to make a reservation.

Another important feature of the system to facilitate marketing may be that member X who has a first degree connection to member Y, may go into member Y's personal network services provider folder within the BHIVE® network and see what services and providers of the network operator that member Y may currently be used, so member X may not view private details of transactions but may see the name and the contact name of the service providers. If member X looks to hire or contract an accountant member X and looks in his friend's contact folder on the BHIVE® network, he may be influenced by member Y's selection of an accountant, reads about that accountant's ratings by his contact member Y (i.e., as all users of service providers rate each service provider they use) and member X then goes to use or transact with that same accountant (i.e., BHIVE® business member). The system to facilitate marketing will note that as a passive referral has taken place (as it may track the referral code in member Y's service folder) and upon member X using or transacting with that same accountant's service, the system to facilitate marketing will record that a passive referral by member Y has taken place (i.e., even though he has not physically referred the accountant's details to member X). It will credit the referral introduction payment back to member Y at the point of member X transacting with his accountant, even though member Y was not a party to any active business referral process. The retrieval of member Y's personal network services folder could happen over any device including mobile phone. So each member will have permission settings on their personal network service provider folder (they decide which members or groups of members they open it up to and those they don't). The network operator will be encouraging this process as it aids greater member referrals within the network, but it will only be done in reference to members with close ties that have first degree connections to one another. Again this may be an example of how the network leverages-off close tie connections as per the Dunbar Rule of 150 and social business networks.

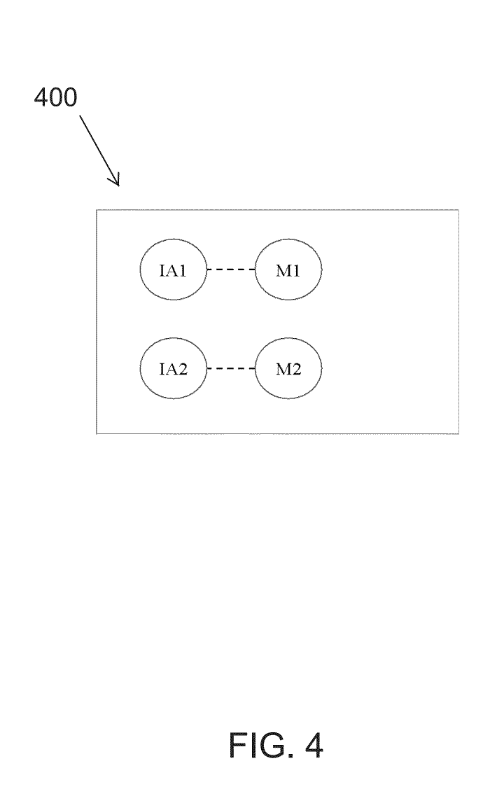

FIG. 4 illustrates a diagram of an introducer affiliate system 400, in accordance with one embodiment of the present invention.

One of the advantages of the system to facilitate affiliate marketing 100 is that it encourages strong interactions between members (i.e. member-member interactions), in addition to interactions between the network operator and members (i.e. member-system interactions). These member-member interactions are important for speeding-up the growth of the system to facilitate affiliate marketing 100 and for helping the business members to grow.

Introducer affiliates IA1 and IA2 sign-up new members M1 and M2, respectively, to the introducer affiliate system 400. IA1 and IA2 cannot be paid any rewards at this stage as M1 and M2 have not yet conducted any business transactions with other members of the introducer affiliate system 400. A first introducer affiliate (IA1) introduces a new business member (M1) to the introducer affiliate system 400. At this stage, M1 and M2 have not conducted any business transactions with other members of the introducer affiliate system 400 so the introducer affiliates IA1 and IA2 cannot be entitled to receive any rewards. The affiliate IA2 could be a consumer, business member or sales agent or indeed the network operator could even be the introducing party.

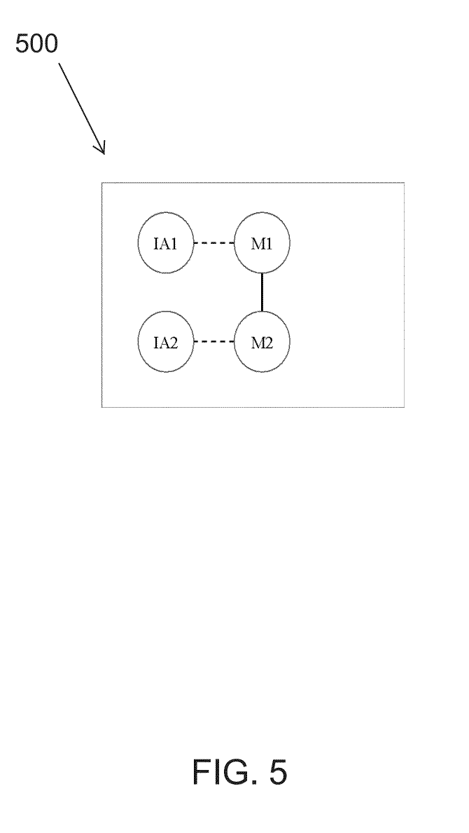

FIG. 5 illustrates a diagram of an introducer affiliate system 500, in accordance with one embodiment of the present invention.

Member M2 purchases a product from member M1. This triggers the introducer affiliate system 500 to pay each introducer affiliate IA1 and IA2 a reward. The introducer affiliate system 500 also pays reward points to M1 and M2 for transacting with a member of the introducer affiliate system 500. FIG. 5 shows a continuation of FIG. 4 at a later stage where member M2 purchases a product from member M1. This triggers the introducer affiliate system 500 to pay a reward to both of the introducer affiliates IA1 and IA2. The transaction also triggers the introducer affiliate system 500 to pay reward points to both members M1 and M2 in return for transacting within the introducer affiliate system 500. The introducer affiliates IA1 and IA2 did not play a role in introducing M1 and M2 to each other and may therefore not be rewarded as referral affiliates.

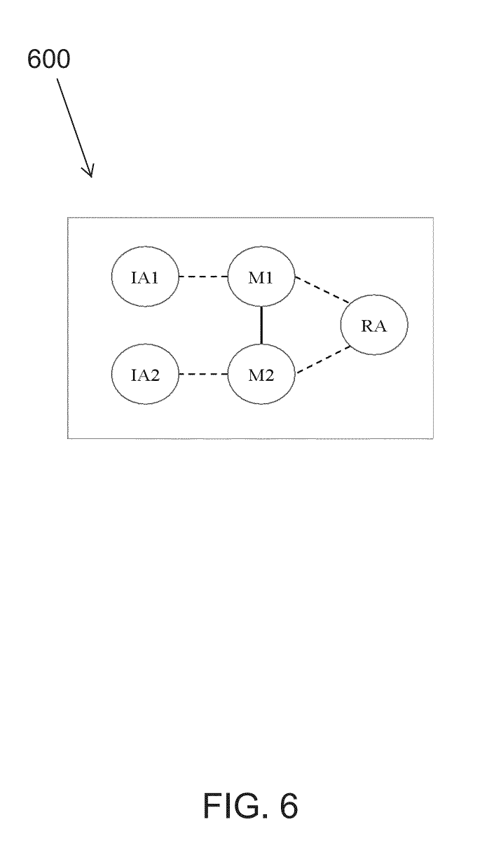

FIG. 6 illustrates a diagram of a referral affiliate system 600, in accordance with one embodiment of the present invention.

A member referral affiliate or RA, who has a first-degree connection with M1 and M2, refers M2 to M1. A reward payment to a RA is triggered when M1 and M2 complete a business transaction with each other. FIG. 6 shows an example of the referral affiliate system 600 applied to FIG. 4. A RA personally knows member M2 and has previously used the services of M1. The referral affiliate then recommends the services of M1 to member M2. As a result, M2 decides to make a purchase from M1. This transaction triggers the referral affiliate system 600 to pay a reward to each RA, M1 and M2. Each reward is in the form of money and/or reward points (money is only paid if the member is a sales agent). M1 also receives new business and M2 has the benefit of quickly finding a business based on a trusted referral. Member M2 could be a consumer, a business member, a network operator or a sales agent. Alternatively, if M1 and M2 may be introduced to each other by the referral affiliate system 600 without any involvement from RA, then there will be no payment of a referral affiliate reward.

The rewards paid to introducer affiliates and referral affiliates will be a split of a total pool of funds paid by the business member to the referral affiliate system 600. The size and split of the funds depend on the marketing agreement negotiated with each business member. There may be many ways in which the referral affiliates set-up marketing arrangements to attract funds from business members.

Referring to FIG. 5, all of the parties will be rewarded to some extent. Each party receives a split of a pool of funds paid by M1 to the referral affiliate system 600 as part of a negotiated marketing agreement. The splits may be as follows: IA1 receives 20% for operating as an introducer affiliate with M1, IA2 receives 2% for operating as an introducer affiliate with M2, M1 receives 2% for selling within the referral affiliate system 600, M2 receives 48% for buying within the referral affiliate system 600 and the Network Operator receives 20%. If the pool of funds is $500, then IA1 would receive $100, and so on.

Referring to FIG. 6, all of the parties will be rewarded to some extent. Each party receives a split of a pool of funds paid by M1 to the referral affiliate system 600, as follows: IA1 receives 20% for operating as an introducer affiliate with M1, IA2 receives 2% for operating as an introducer affiliate with M2, M1 receives 2% for selling within the referral affiliate system 600, M2 receives 48% for buying within the referral affiliate system 600, the Network Operator receives 20% and an additional 20% if also in IA1's position as introducer rather than sales agent and RA receives between 8-18% (paid last so amount will vary based on other parties splits of the pool). If the pool of funds is $500, then IA1 would receive $100, and so on.

Note that the introducer affiliate has the opportunity to introduce both the buyer and seller to the introducer affiliate rewards system. This is significant both in terms of affiliates' higher income potential and stability of income by bringing in a diversity of sellers and buyers, and particularly seller industries. It also helps merchants in terms of more efficient matching on leads, so there is a higher probability of the transaction closing. Conventional affiliate marketing systems do not typically have this feature. Example: Splits for referral affiliate process (Where Business Member services are being sold as per FIG. 4). Rates quoted below will vary when Network Operators own products and services are sold.

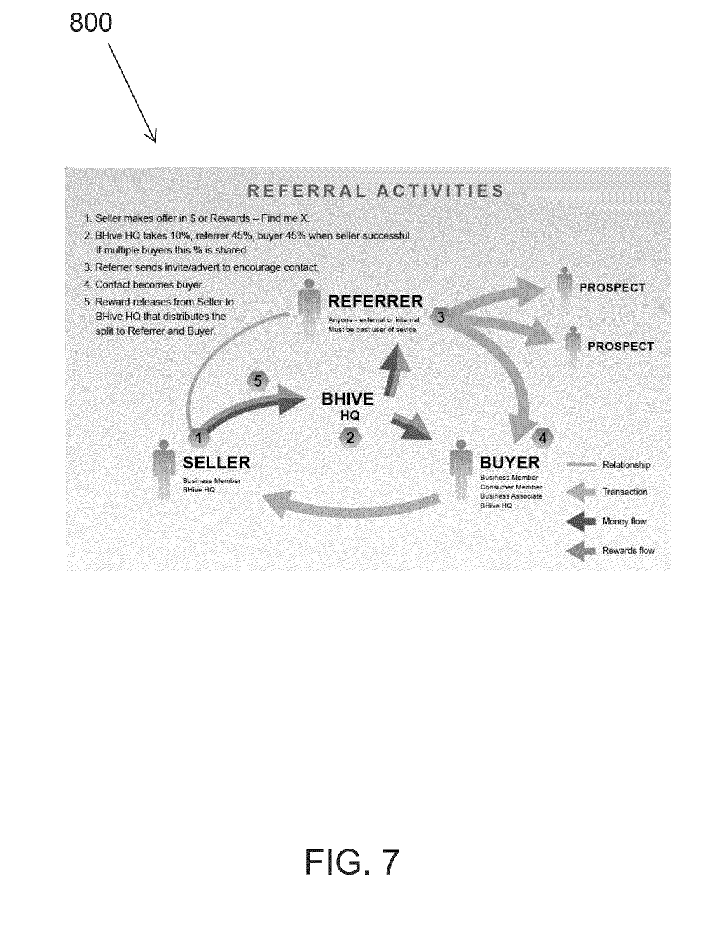

FIG. 7 illustrates a reward and income challenge mechanism, a diagram of a plurality of revenue splits of a referral affiliate rewards system 800, in accordance with one embodiment of the present invention. FIG. 7 shows an example of a referral affiliate process in which a seller offers to pay a performance fee (in addition to the network's reward) for finding a client. The buyer might specify that the client must fit a particular profile, such as being from a certain industry or have a turnover greater than $1 m.

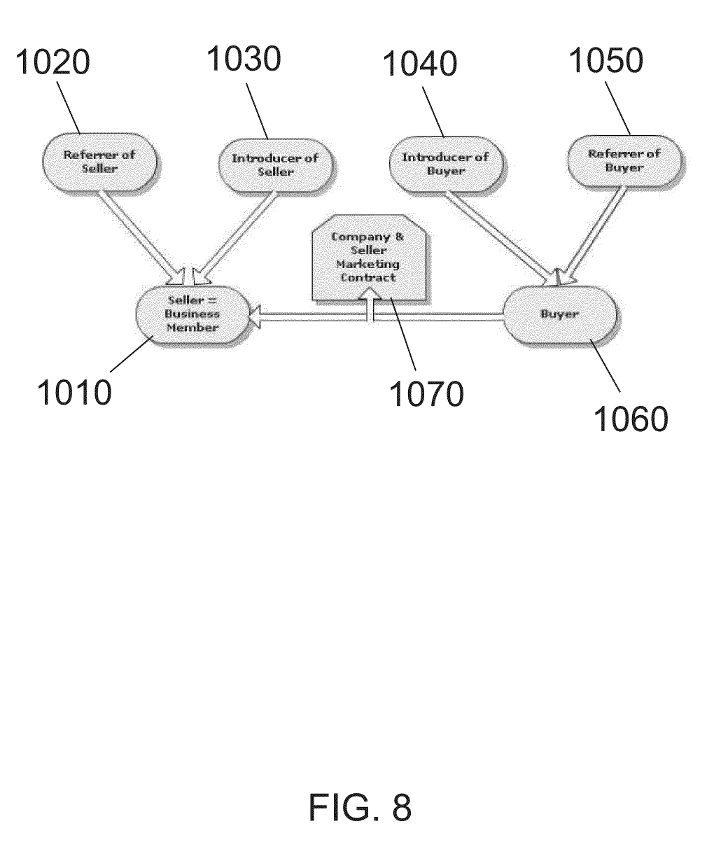

There are five steps in this example, as shown in FIG. 8. The seller publishes a reward open to any member who is able to refer potential buyers for a particular product or service. In other words, this is an offer to members to act as a referral affiliate. The reward may be an offer of cash, reward points or a combination of cash and reward points. Splitting of the reward is agreed. In this case, the split is 10% of the reward is paid to the network operator (in this case BHIVE®), 45% is paid to the referral affiliate and 45% is paid to the buyer. The network operator is paid immediately, but the referral affiliate is only paid when the seller completes a sale with the buyer (referred by the affiliate). The referral affiliate sources potential buyers (prospects) by direct invitations and advertisements. One of the potential buyers makes a purchase from the seller. The 45% rewards are released from the seller to the referral affiliate, who will only get paid from funds the seller gives first to the network operator. The network operator itself may also sell products and services to members.

Members are given incentives, such as higher search rankings, to encourage them to conduct transactions via the network. For example, members may be given higher search rankings based on the frequency of transactions, the size and total of those transactions, the user ratings they receive from members, the level of their referrals to the network, the level of their personal spending, and so on.

Additionally, advertising fees are paid by members for advertisements or promotions within the network. Since the network operator has access to data about its members, it is able to target members who are more likely to be interested in the advertisement or promotion. Examples of types of advertising or promotion that attract a fee include, but are not limited to, bulk advertising campaigns, such as by mobile SMS or email, directed at members in a target demographic. For example, an SMS message sent to all members within 50 km of the Sydney CBD who work as an electrical engineer. There are also contacting members from time to time in response to their expressions of interest in specific goods, services or topics. Members may notify the network operator at initial registration, or at any other time, that they are interested in finding a supplier of particular goods or services, or are interested in receiving information about a particular topic. The network operator searches for members who appear to be relevant to the members' area of interest. For example, when a member notifies the network operator that they are interested in finding a marine mechanic in the Sydney area, the network operator searches for sellers who meet those criteria (i.e., the network operator performs a reverse matching function). The network operator may send a message to the member to advise the contact details of a relevant seller. Alternatively, the network operator may send a message to each relevant seller to advise the contact details of interested members. Either way, the seller, and optionally also the buyer, pays a fee for this service. The network operator may supply member data to other members, who may use the member data in their own advertising or promotional campaign. The member data may be contact details of members who meet specific demographic criteria. For example, the member data may be the names of all financial planners within a 20 km radius on the Sydney CBD. The network operator may offer members speaking opportunities at paid business events. For example, the members may be charged directly or there may be a profit split on the proceeds on ticket sales. The network operator may also charge training fees paid by members for training courses, such as online courses and charge events fees paid by members to attend events arranged by the network operator. Events may be online or in person. For example, the network operator may arrange business matching events, such as lunches in which potentially compatible members are invited. The network operator may also charge marketing licence—fees paid by sales agents for the right to act as a sales agent of the network operator and digital card design fees paid by members to create a digital version of a business card which they may use in various ways, including referrals and premium consumer account fees paid by consumer members for extra features associated with their membership. There are many options, such as premium seating at events, higher rewards and group buying discounts. The network operator may charge premium business account fees paid by business members for extra features associated with their membership. There are many options, for example priority search rankings and under premium consumer accounts. The network operator may charge e-commerce transaction fees paid for each electronic transfer of funds where an e-commerce system is included in the network to facilitate member-to-member transactions. The fees may be very low, and may be aimed at recovering the cost of operating the e-commerce system. The fees apply to transactions conducted with reward points and with money. The network operator may also charge profit sharing. A portion of financial turnover in the network is returned to members in the form of reward points and money. The network may return higher amounts to members who contribute to the growth of the network. For example, BHIVE® Network may return on a monthly basis 50% of all profit to members who help to grow the network. Select members depending on performance will partake in the distribution of profit and be given dividend shares

FIG. 8 illustrates a block diagram of one or more business members selling one or more products and services, in accordance with one embodiment of the present invention.

The block diagram may include one or more business members 1010, a referrer of one or more sellers 1020, an introducer of one or more sellers 1030, one or more buyers 1040, an introducer of one or more buyers 1050, a referrer of one or more buyers 1060 and a buying contract 1070. The one or more business members 1010 may operate as an introducer affiliate for both consumer members and also other business members and a referral affiliate for all types of members. The referrer of one or more sellers 1020 may refer one or more sellers to the one or more business members 1010.

In FIG. 8 (which illustrates the model when business members are selling their services) in this situation all 4 member types (Network Operator, Business Member, Rewards Member and Business Associate) may occupy any of the 4 positions in the top row as well as that of the Buyer position, but only the Business Member can occupy the selling role.

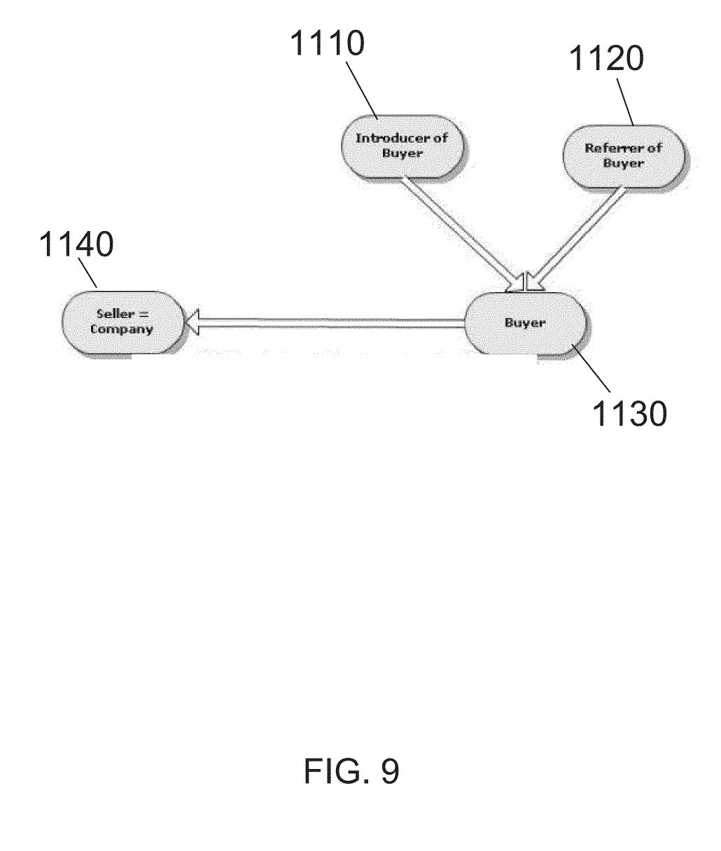

FIG. 9 illustrates a block diagram of a BHive the company (Network Operator) selling one or more of its products and services, in accordance with one embodiment of the present invention. In this situation all 4 member types (Network Operator, Business Member, Rewards Member and Business Associate) may occupy any of the 2 positions in the top row as well as that of the Buyer position, but only the Company (Network Operator) can occupy the selling role. Benefits of the network to consumers include an opportunity to earn reward points, gain access to ratings and feedback about sellers in the network, an opportunity to efficiently notify sellers when needing particular goods or services and to request offers and quotes from relevant sellers and an opportunity to share the profits of the network. Benefits of the network to business members include an opportunity to attract clients, an opportunity to reduce marketing cost, a network directory that makes it easier for buyers to find an appropriate seller and an opportunity to increase the proportion of leads who convert to clients, and to shorten the sales process. The trust created by personal referrals and user ratings may be a powerful influence on a person's decision to buy. The benefits of the network to business members include an opportunity to better market to their target audience, an opportunity to be notified when a potential buyer has a need for goods or services, an opportunity to earn reward points, an opportunity to share the profits of the network, an opportunity to be promoted by the network and no financial risk in joining as there is no membership or joining fee. There are optional services that the member may take up if desired.

Benefits of the network to sales agents include an opportunity to earn reward points, an opportunity to share the profits of the network, an opportunity to earn a residual income from a large number of stable business members and an opportunity to monetise social networks and contact databases. Benefits of the network to network operators include an opportunity to earn money, an opportunity to be influential in the business community, develop a valuable database, develop strong business partnerships, contributes to charity and community projects and promotion using a large-scale commission-only sales force.

While the present invention has been related in terms of the foregoing embodiments those skilled in the art will recognize that the invention may be not limited to the embodiments described. The present invention may be practiced with modification and alteration within the spirit and scope of the appended claims. Thus, the description may be to be regarded as illustrative instead of restrictive on the present invention.

What is claimed is:

1. A system to facilitate affiliate marketing, comprising:
a server system with a first processor system, a communications interface, a first communications system, a first input system and a first output system, the server system having access to a communications network;
a first memory system with an operating system, a communications module, a web browser module, a web server application and an affiliate marketing facilitation application, the first memory system residing on the server system;
a website with a plurality of web pages to receive a plurality of affiliate marketing data, the website residing on the affiliate marketing facilitation application; and
a plurality of users, wherein the users are a plurality of members of the system to facilitate affiliate marketing, the users include:
a plurality of sellers supplying one or more goods or services to the system to facilitate affiliate marketing;
a plurality of buyers purchasing the one or more goods or services to the system to facilitate affiliate marketing;
a plurality of introducer affiliates introducing one or more new users to the system to facilitate affiliate marketing;
a plurality of referral affiliates referring a potential buyer to a potential seller, or referring a potential seller to a potential buyer;
a network operator operating and maintaining the system to facilitate affiliate marketing; and
a network wide rewards system for all members that is redeemable against its business members own services as funded and executed by the network operator.

2. The system to facilitate affiliate marketing according to claim 1, further comprising a client system, the client system includes a second output system, a second input system, a second memory system, a second processor system and a second communications system.

3. The system to facilitate affiliate marketing according to claim 2, wherein the client system accesses the server system via the communications network.

4. The system to facilitate affiliate marketing according to claim 1, further comprising a plurality of incentives to the users.

5. The system to facilitate affiliate marketing according to claim 4, wherein the incentives include a plurality of rewards points, one or more monetary payments, a plurality of membership data and one or more search rankings of an online business directory.

6. The system to facilitate affiliate marketing according to claim 1, further comprising a plurality of user reward systems.

7. The system to facilitate affiliate marketing according to claim 6, wherein the reward systems include an introducer affiliate reward system and a referral affiliate reward system.

8. A system to facilitate affiliate marketing that hosts an online business network cooperative, comprising:
a server system with a first processor system, a communications interface, a first communications system, a first input system and a first output system, the server system having access to a communications network;
a first memory system with an operating system, a communications module, a web browser module, a web server application and an affiliate marketing facilitation application, the first memory system residing on the server system;
a website with a plurality of web pages to receive a plurality of affiliate marketing data, the website residing on the affiliate marketing facilitation application;
a plurality of users, wherein the users are a plurality of members of the system to facilitate affiliate marketing, the users include:
a plurality of sellers supplying one or more goods or services to the system to facilitate affiliate marketing;
a plurality of buyers purchasing the one or more goods or services to the system to facilitate affiliate marketing;
a plurality of introducer affiliates introducing one or more new users to the system to facilitate affiliate marketing; and
a plurality of referral affiliates referring a potential buyer to a potential seller, or referring the potential seller to the potential buyer; and
a network operator operating and maintaining the system to facilitate affiliate marketing;
a plurality of incentives to the users; and
a plurality of reward systems to the users.

9. The system to facilitate affiliate marketing according to claim 8, further comprising a client system, the client system includes a second output system, a second input system, a second memory system, a second processor system and a second communications system.

10. The system to facilitate affiliate marketing according to claim 9, wherein the client system accesses the server system via the communications network.

11. The system to facilitate affiliate marketing according to claim 8, wherein the incentives include a plurality of rewards points, one or more monetary payments, a plurality of membership data and one or more search rankings of an online business directory.

12. The system to facilitate affiliate marketing according to claim 8, wherein the reward systems include one or more introducer affiliate reward systems.

13. The system to facilitate affiliate marketing according to claim 12, wherein the one or more introducer affiliate reward systems includes one or more splits.

14. The system to facilitate affiliate marketing according to claim 13, wherein the one or more introducer affiliate reward systems include a performance fee.

15. The system to facilitate affiliate marketing according to claim 8, wherein the reward systems include one or more referral affiliate reward systems.

16. The system to facilitate affiliate marketing according to claim 15, wherein the one or more referral affiliate reward systems includes one or more splits.

17. The system to facilitate affiliate marketing according to claim 16, wherein the one or more referral affiliate reward systems include a performance fee.

18. The system to facilitate affiliate marketing according to claim 8, wherein the online business network cooperative sells one or more products and services to the users.

19. The system to facilitate affiliate marketing according to claim 18, wherein the network operator sells the one or more products and services to the users.

20. The system to facilitate affiliate marketing according to claim 18, wherein the one or more products and services includes one or more splits.
